(19) United States
(12) Patent Application Publication
(10) Pub. No.: US 2006/0166721 A1
(43) Pub. Date: Jul. 27, 2006

(54) Wireless communications system and method

(75) Inventor: Yong Sun, Bristol (GB)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Minato-ku (JP)

(21) Appl. No.: 11/261,512

(22) Filed: Oct. 31, 2005

(30) Foreign Application Priority Data
Jan. 21, 2005 (GB) 0501333.9

(51) Int. Cl. H04M 1/00

(52) U.S. Cl. 455/575.7

(57) ABSTRACT

A MIMO communications device comprises a detector and an antenna, the antenna comprising a plurality of antenna elements. Each antenna element is operable to receive a signal carried on electromagnetic radiation impinging on the antenna element substantially aligned with a predetermined direction relative to the antenna element, the antenna elements being aligned relative to each other such that with respect to the predetermined receiving directions of said antennas the antennas are relatively angularly displaced from each other. A corresponding method of conducting communication in a MIMO system is also disclosed, comprising the steps of determining, for a given device, a preferred direction of communication with other devices in the system, and scheduling communication with said other devices in directions corresponding to said detected preferred directions of communication.

This invention relates to a wireless communications system and in particular is concerned with a wireless communications system operable with multiple inputs and outputs (MIMO).

In modern wireless communication systems, there is a continuing need for ever higher data rates to be achieved. However, there is a conflicting need to limit the power consumption and complexity of devices used in a wireless communications system, and bandwidth may be limited such as for regulatory reasons.

In order to take account of these limitations, multiple input, multiple output (MIMO) communication has become increasingly popular. MIMO provides high spectral efficiency, as it utilizes advantageously the effect of scattering as a result of environmental issues, such as obstacles in the pathway between a transmitter and a receiver, and/or walls, buildings etc. A rich scattering environment provides independent transmission paths from each transmit antenna of an antenna array, to each receive antenna of the receive antenna array.

It will be appreciated by the skilled reader that use of the term MIMO is not intended to exclude Multiple Input, Single Output (MISO) communication which is a subset of the general case.

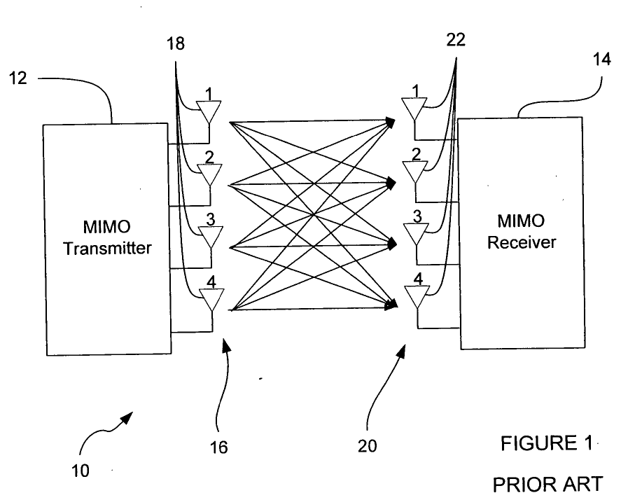

Typically, a MIMO system is implemented using devices having antennas arranged in linear arrays. FIG. 1 illustrates such a system 10, comprising a MIMO transmitter 12 and a MIMO receiver 14. The MIMO transmitter 12 has a transmit antenna array 16 comprising four transmit antennas 18 arranged in a linear array, while the minor receiver 14 comprises a receive antenna array 20 comprising four receive antennas 22, also linearly arranged. This MIMO system is thus described as a 4×4 MIMO system.

Whereas such a conventional MIMO structure provides a system which is easily analysed, due to geometric simplifications, and is thus preferable for simulation study, wireless communication using such a MIMO system achieves capacity on a number of separate channels which approximates to the lower of the number of transmit antennas and the number of receive antennas.

Further limitations of such a MIMO system concern the absence of any consideration of power received at receiving antennas. Power efficiency is not taken into account, and only point-to-point applications are considered. It would be desirable to be able to manage power more effectively.

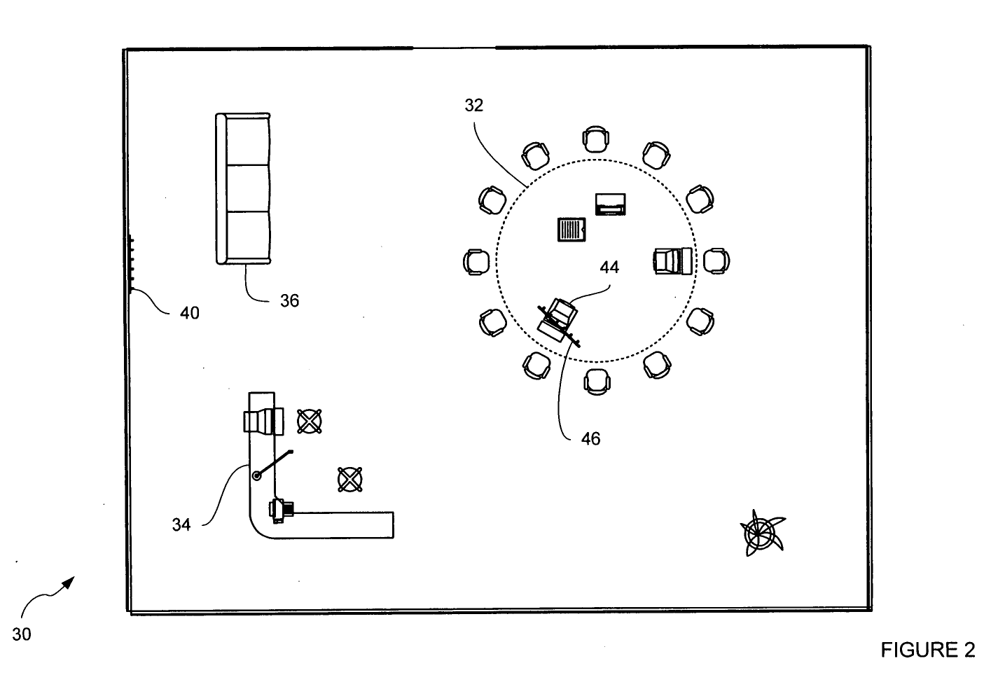

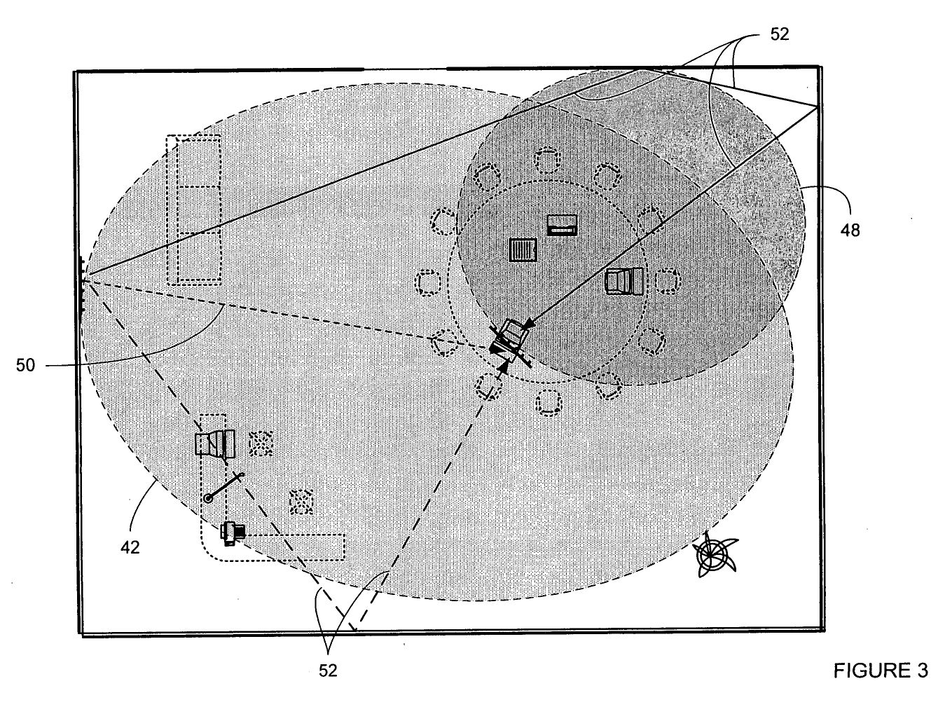

FIG. 2 illustrates a potential arrangement using MIMO communication. For reasons of clarity, FIG. 3 illustrates, over a replica of FIG. 2, power profiles and transmission rays to explain the operation of the system illustrated in FIG. 2. The arrangement is established within a room 30, comprising various items of furniture, including a conference table and chairs 32, a desk 34 and a sofa 36. A base station 40 is attached to one wall. The base station is a linear array of antennas.

The transmission and reception power profile of the base station 40 is illustrated, alongside the profile of the room and furniture, in FIG. 3. The transmission and reception profile of the base station 40 is represented by broken line 42 in FIG. 3, being a radial graph about the centre point of the linear array of the base station 40. Thus, it will be appreciated that the transmission and reception of signals by the base station has a directional profile, with transmission and reception in a direction substantially perpendicular to the direction of the linear array being relatively high, while the transmission and reception of signals at very acute angles with regard to the direction the linear array of the base station 40 remaining low or negligible.

A mobile terminal 44 comprising a transmit/receive antenna array 46 is positioned on the conference table, and its transmit and receive power profile is indicated by broken line 48 in FIG. 3. It will thus be appreciated that the wave transmitted by the base station 40 directly to the mobile terminal 44 cannot be received by the mobile terminal 44. This wave is indicated by dotted ray 50.

It will be appreciated that the use, in the appended drawings, of rays to indicate the transmission of electromagnetic excitations is merely illustrative, and is not intended to indicate a power distribution profile—even in the case of a highly directional antenna arrangement, a wave of determinable amplitude will be transmitted over a finite angular range.

Similarly, a ray 52 indicative of a wave reflecting off a single wall and back to the mobile terminal 44, can also not be received by the mobile terminal. In fact, the only example of a wave that can be received by the mobile terminal from the base station 40 is that indicated by ray 54 in FIG. 2. It will be appreciated that another mobile station could be placed on the desk, and thus take advantage of the ability to communicate between the base station and that mobile station along the ray indicated 52. Downlink capacity is expressed as:

$${C}_{DL} = {max}_{{R}_{{x}_{k} {x}_{k}} , ∀ k} {\sum }_{k = 1}^{K} {log}_{2} \frac{det ( {R}_{{z}_{k} {z}_{k}} + {H}_{k} {R}_{{x}_{k} {x}_{k}} {H}_{k}^{H} )}{det ( {R}_{{z}_{k} {z}_{k}} )}$$

$$subject to {\sum }_{k = 1}^{K} trace ( {R}_{{x}_{k} {x}_{k}} ) \leq max {P}_{BS}$$

$$where {R}_{{z}_{k} {z}_{k}} = {R}_{{n}_{k} {n}_{k}} + {\sum }_{p = 1 , p \neq k}^{K} {H}_{k} {R}_{{x}_{p} {x}_{p}} {H}_{k}^{H}$$

Rₓ_{ₖ}ₓ_{ₖ} is the matrix of covariances for the received observation at the receiving antennas, and Hₖ is the channel matrix. Optimally,

$${\sum }_{p = 1 , p \neq k}^{K} {H}_{k} {R}_{{x}_{p} {x}_{p}} {H}_{k}^{H} = 0.$$

By aiming for optimally zero interference interference,

$${\sum }_{p = 1 , p \neq k}^{K} {H}_{k} {R}_{{x}_{p} {x}_{p}} {H}_{k}^{H} ,$$

an ideal spatial separation is suggested. Further, by constraining power,

$${\sum }_{k = 1}^{K} trace ( {R}_{{x}_{k} {x}_{k}} ) \leq max {P}_{BS} ,$$

a shared version of Base Station power is implied.

Similarly, uplink capacity is expressed as:

$${C}_{UL} = {max}_{{R}_{{x}_{k} {x}_{k}} , ∀ k} {log}_{2} \frac{det ( {R}_{nn} + {\sum }_{k = 1}^{K} {H}_{k} {R}_{{x}_{k} {x}_{k}} {H}_{k}^{H} )}{det ( {R}_{nn} )}$$

$$subject to trace ( {R}_{ {x}_{ k} {x}_{ k}} ) \leq max P$$

For the uplink, if it is assumed that the total number of antennas of active mobile stations is the same as that at the base station, the uplink can be seen as a large MIMO system.

The term Hₖ Rₓ_{ₖ}ₓ_{ₖ} Hₖ^{H} in this process is required to decorrelate multiple users and/or multiple channels. The conditions placed on these calculations relating to

$${\sum }_{k = 1}^{K} trace ( {R}_{{x}_{k} {x}_{k}} ) and trace ( {R}_{{x}_{k} {x}_{k}} )$$

are to take account of power control and power participation.

Thus it will be appreciated that the energy received by the mobile terminal 44 is significantly less than half of the energy it should receive if it were able to receive directly waves transmitted along the main wave path indicated by ray 50. This is the direct strongest path and is blocked in the arrangement illustrated in FIG. 2. Thus, channel measurements taken at the mobile station 44 will be distorted by the fact that the mobile station is incorrectly positioned, and inefficient communication may therefore arise.

Further, the use of MIMO in a system with a plurality of users (i.e. more than two devices networked with each other) compounds this problem. Significant power must be expended in order to provide acceptable channel power levels at each receiving antenna, as much power is unreceiveable, due to scattering, obstacles or misalignment of antennas.

It is thus desirable that an aspect of the invention provide apparatus and a process for establishing MIMO communication in a wireless network, to improve on the situation described above.

It is further desirable that an aspect of the invention provide a comprehensive reconfigurable system for multi-user MIMO system. In order to achieve high potential system performance, this work is only considering full system capacity, rather than a single-link MIMO capacity.

A first aspect of the invention provides a MIMO system comprising at least two MIMO communications devices, at least one of which comprises antenna means, said antenna means including an angularly sectorised antenna array.

Preferably, each of the communications devices comprises antenna means including an angularly sectorised antenna array. One of the communications devices may be a base station, the or each other being a mobile station, the base station being operable to determine, with each mobile station, directional MIMO communication in said system.

The directional MIMO communication may be configured by detecting, at each mobile station, signal to noise plus interference ratio, and then feeding back detected signal to noise plus interference information to the base station, for the base station then to make a scheduling decision based thereon.

The antenna means at the or each mobile station may include multiple omnidirectional antennae.

The multiple omnidirectional antennae may be arranged without an adaptive array and thus the scheduling process may be performed in relation to communication from the base station to the mobile station and not from the mobile station to the base station. In the alternative, the multiple omnidirectional antennae may be provided with an adaptive array. In this case, in a first mode of operation, the mobile station may be operable to initially detect received power from each of the base station's sector antennas and then apply the adaptive array to each of the base station's sector antennae in order to maximise the signal to noise plus interference. Then, the system may be operable to reselect the best sectors of the base station's antennas to form a MIMO communications channel based on signal to noise plus interference.

In a second mode of operation, the mobile station may be operable to select the best set of antennas of the base stations' sectorised array of antennas, to form a MIMO communications channel based on signal to noise plus interference and then to apply the adaptive array at the mobile station to maximise the MIMO signal to noise plus interference ratio.

The base station may be configured to control transmission power on the basis of fed back information regarding signal to noise plus interference ratio (for each antenna sector) at the mobile station. The base station may be configured to control transmission scheduling (i.e. controlling the operation of sectors of the antenna with regard to the time or frame domain) on the basis of fed back information regarding signal to noise plus interference ratio (for each antenna sector) at the mobile station.

Sectors of the antenna at the base station may be paired. This may improve the efficiency of MAC frame assignment.

An advantage of the invention is that it provides power efficiency which is important to the effective operation of a MIMO system.

The invention also allows the provision of higher capacity to a MIMO system than in conventional MIMO systems.

It further provides a simple configuration for multi-user access to a MIMO system, and a flexible MIMO system to fully combine spatial, time and frequency (if available).

It is a further advantage of an aspect of the invention that it allows the provision of a reconfigurable MIMO system. For each individual link between a mobile station and a base station, the MIMO configuration is reconfigured according to the quality of the link.

Further, in addition to the power efficiency noted above, an aspect of the invention provides other efficiencies, such as communication efficiency.

System control is improved using an aspect of the present invention as opposed to conventional MIMO systems.

An aspect of the invention (using paired sector detection) allows the reduction of overhead (and also a shorter switching guard period). This consequently improves data efficiency.

Using MAC control in accordance with an aspect of the present invention allows the provision of a higher quality communications link than previously available.

The aspect of the invention involving sectorised antennas can be applied to two or three sets of sector-antenna at base stations and mobile stations, to produce a more complex MIMO system than previously achievable.

Specific embodiments of the invention will now be described, by way of example only, with reference to the appended drawings, in which:

FIG. 1 is a schematic diagram of an arrangement of a MIMO transmitter and a MIMO receiver, in accordance with a prior art example;

FIG. 2 is a schematic diagram of a piconet employing MIMO communications technology;

FIG. 3 is a schematic diagram illustrating wireless communication in the piconet illustrated in FIG. 2;

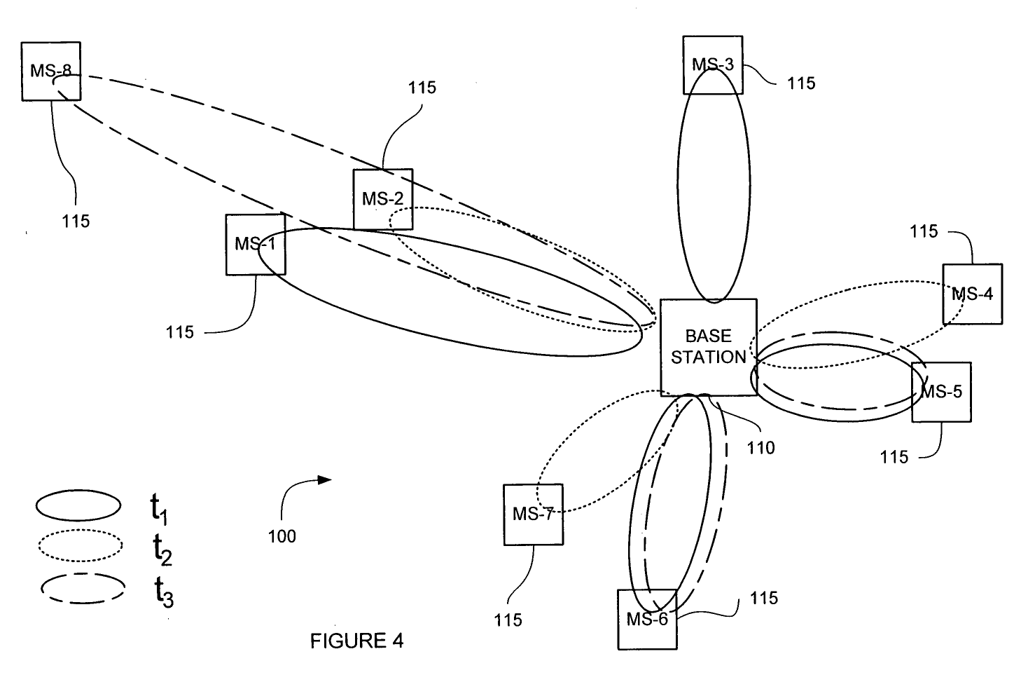

FIG. 4 is a schematic diagram of a communications system in accordance with a first embodiment of the invention;

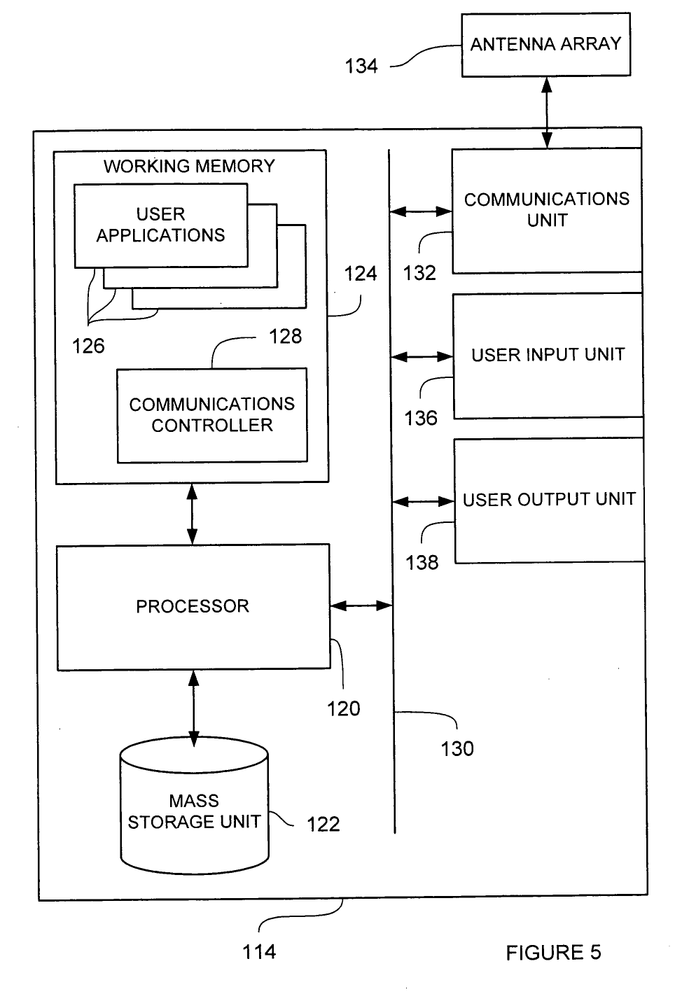

FIG. 5 is a schematic diagram of a base station of the communications system illustrated in FIG. 4;

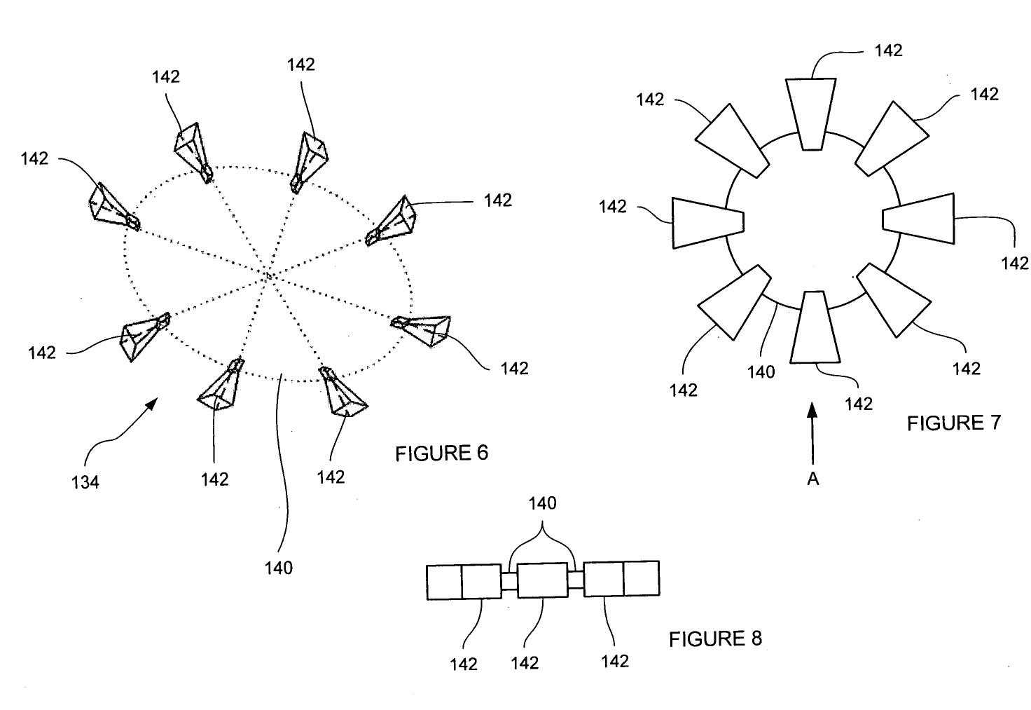

FIG. 6 is a perspective elevation of an antenna array of the base station illustrated in FIG. 5;

FIG. 7 is a plan view of the antenna array illustrated in FIG. 6;

FIG. 8 is a side elevation of the antenna array illustrated in FIG. 7, from the direction indicated by an arrow A;

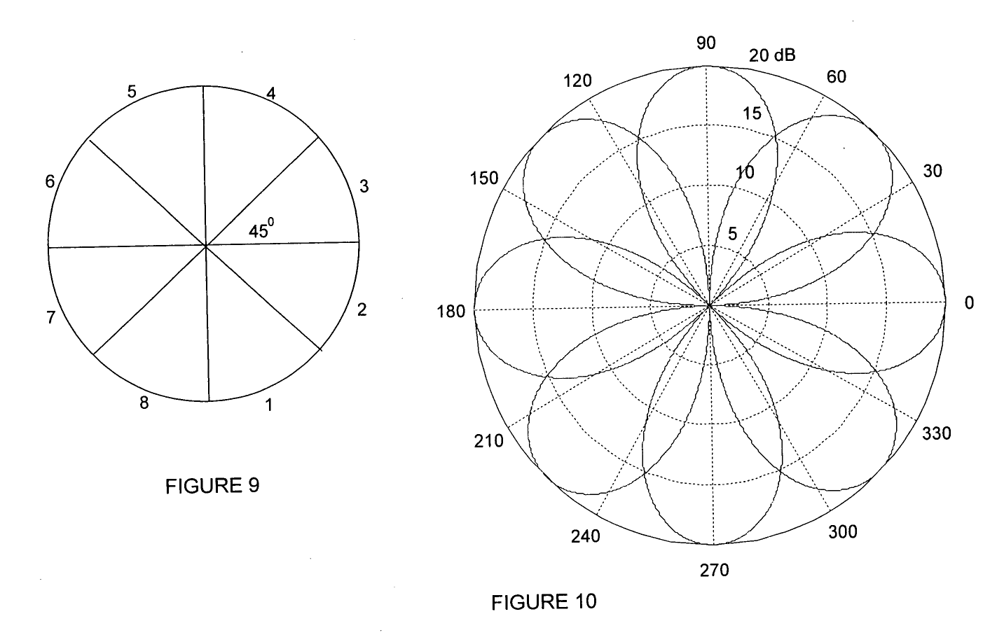

FIG. 9 is a schematic diagram illustrating the orientation of major transmission axes of antennas of the antenna array illustrated in FIGS. 6 to 8;

FIG. 10 is a graph of the transmission power profile of the antenna array illustrated in FIGS. 6 to 9;

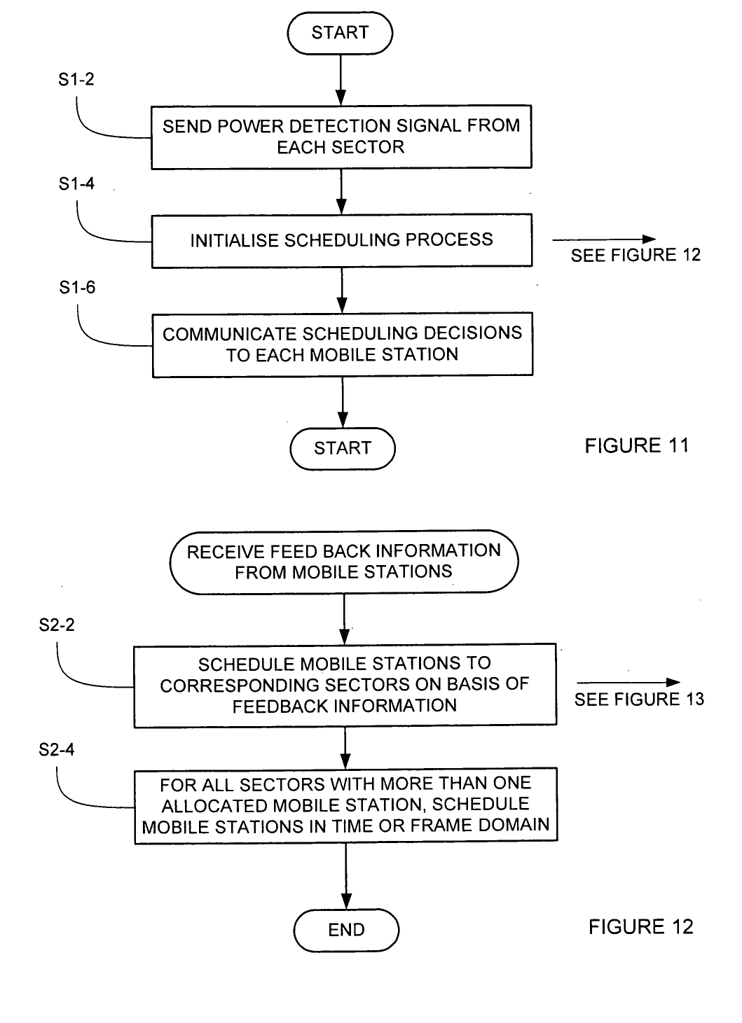

FIG. 11 is a flow diagram of a process of determining a transmission schedule for the base station illustrated in FIGS. 4 and 5;

FIG. 12 is a flow diagram of a scheduling process invoked by the process illustrated in FIG. 11;

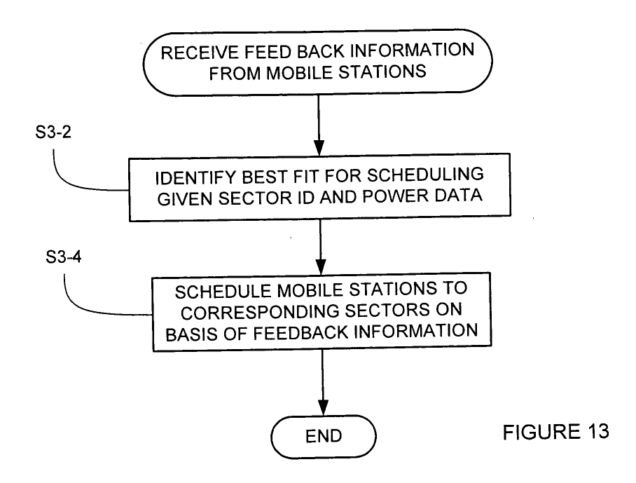

FIG. 13 is a flow diagram of a preliminary scheduling process invoked by the process illustrated in FIG. 12;

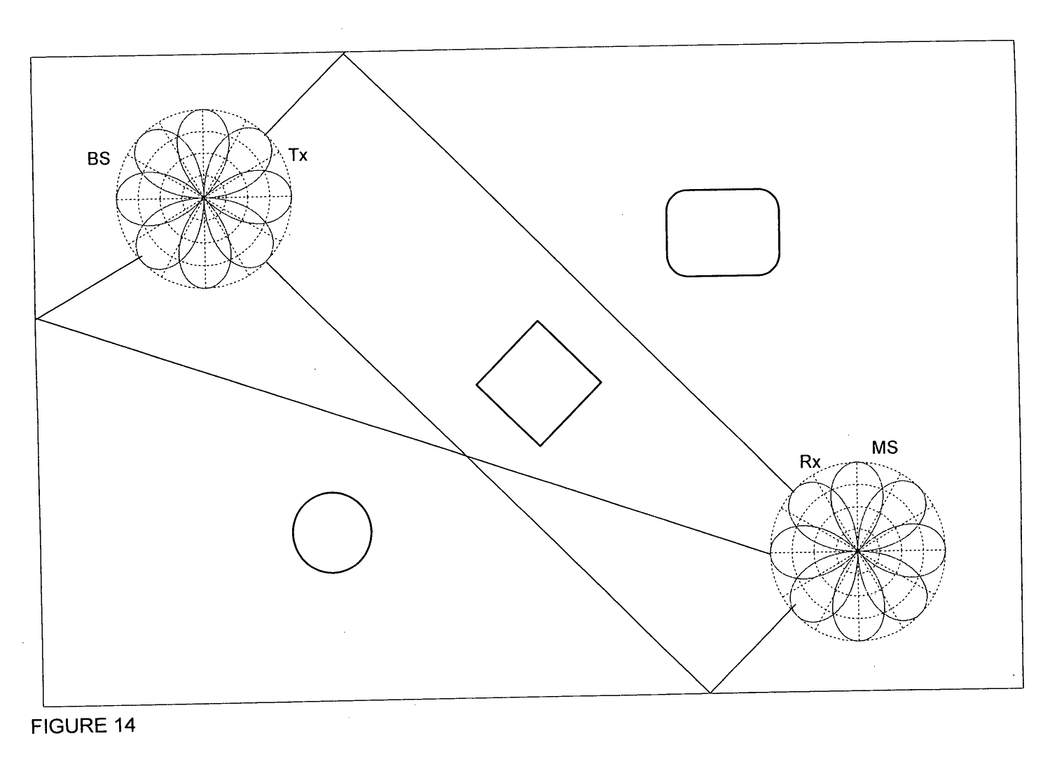

FIG. 14 is a schematic diagram of a communications system in accordance with a second embodiment of the invention;

FIG. 15 is a schematic diagram of the antenna array illustrated in FIGS. 6 to 8, in a first alternative mode of operation;

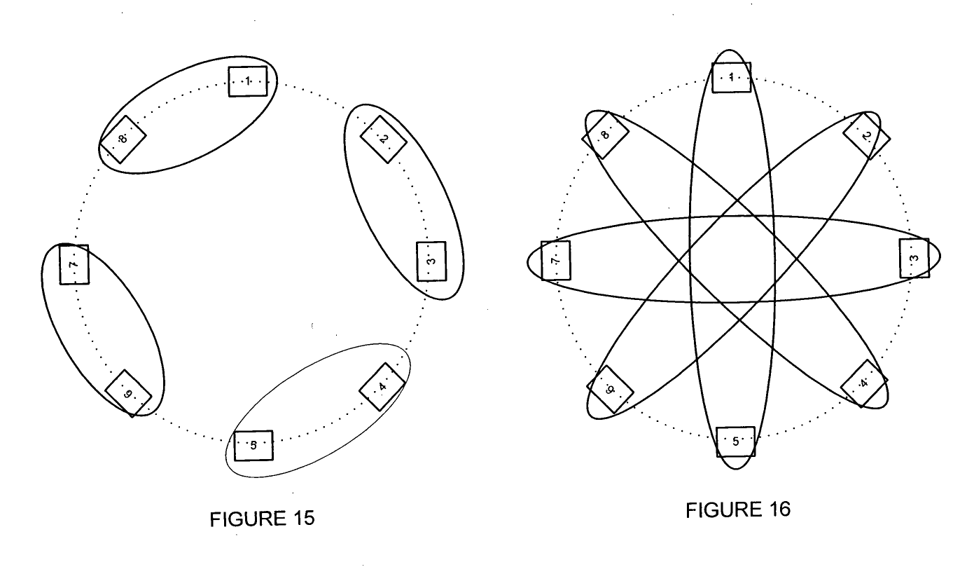

FIG. 16 is a schematic diagram of the antenna array illustrated in FIGS. 6 to 8, in a second alternative mode of operation;

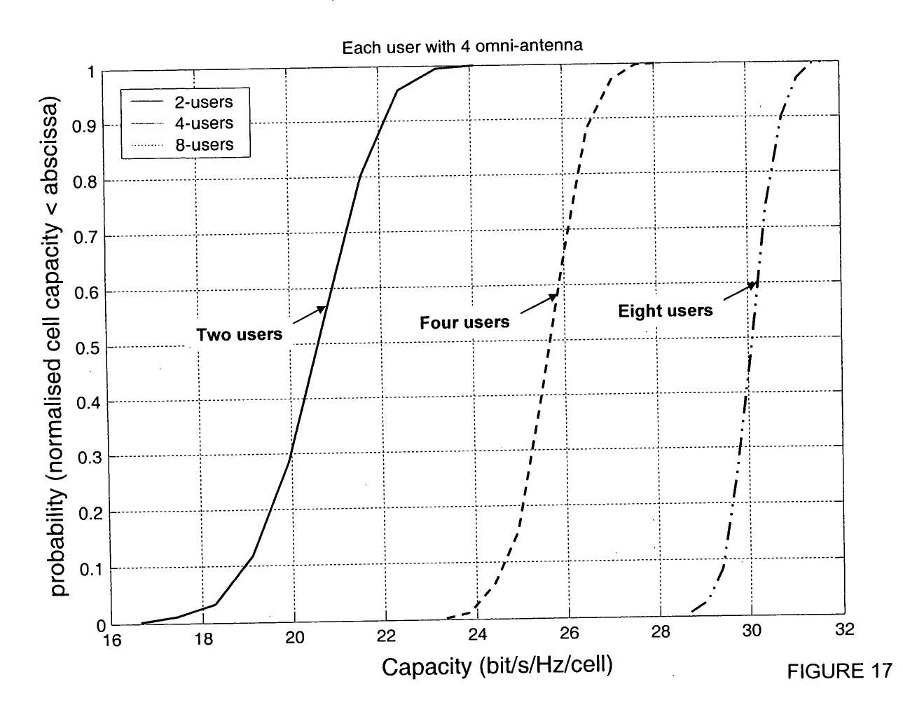

FIG. 17 is a graph of capacity against performance for the base station in the first alternative mode of operation, illustrated in FIG. 15, in the communications system arrangement illustrated in FIG. 4;

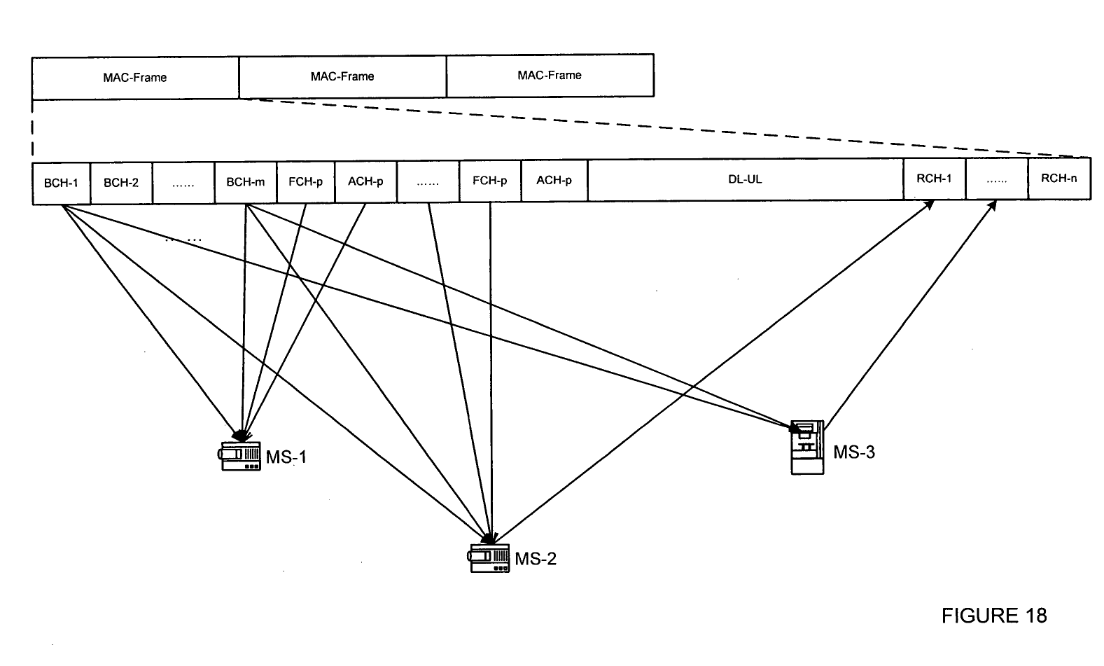

FIG. 18 is a schematic diagram of the structure of data transmitted in the communications system illustrated in FIG. 4;

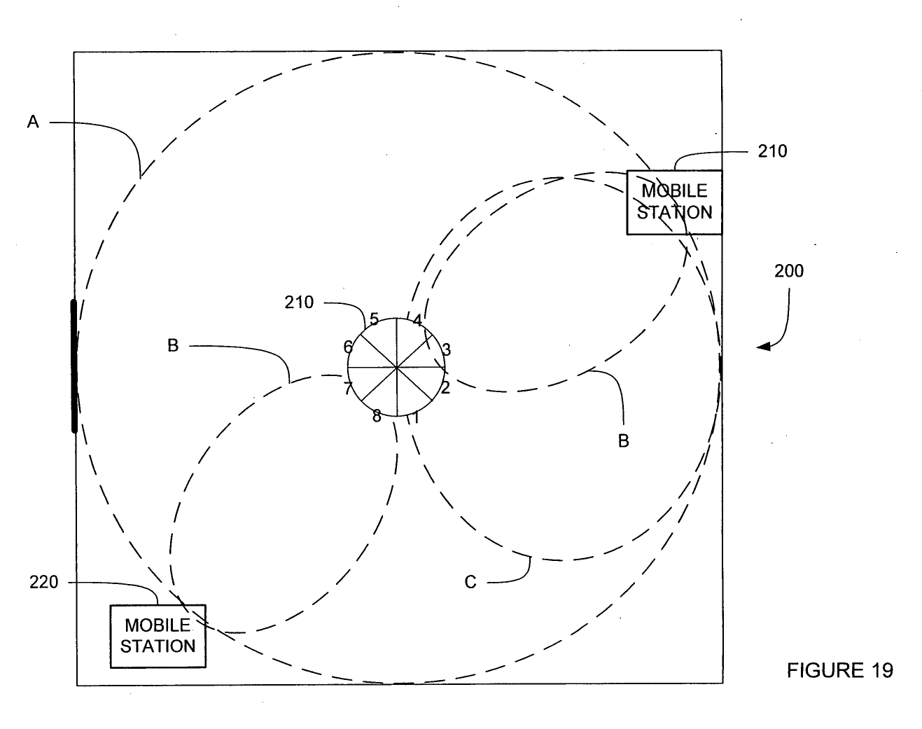

FIG. 19 is a schematic diagram of a communications system in accordance with a fourth embodiment of the invention;

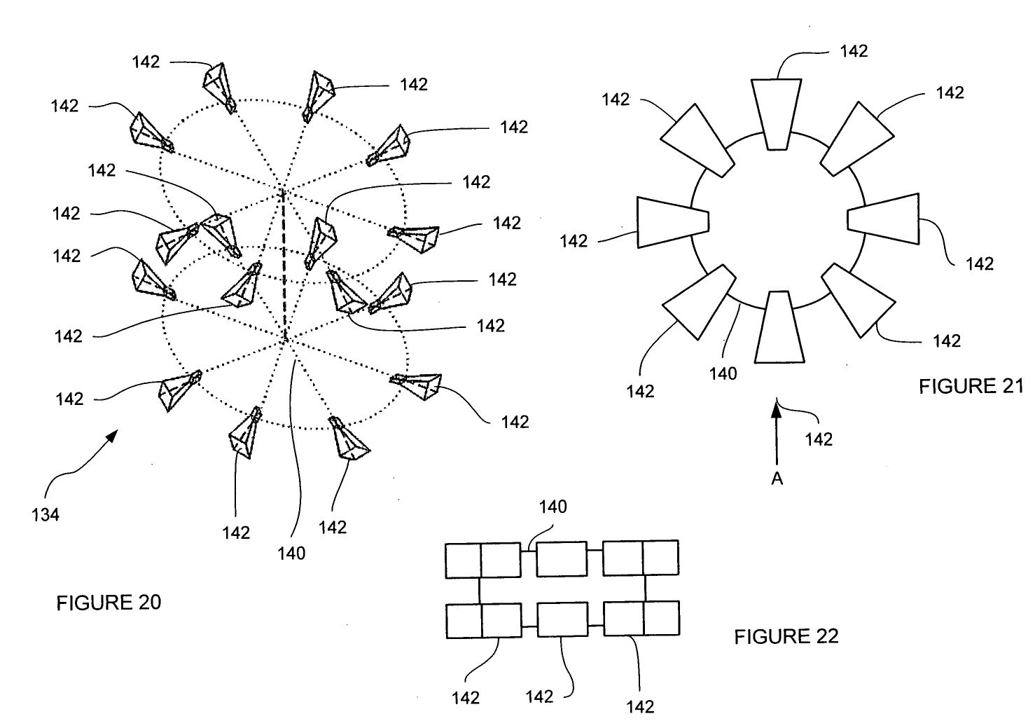

FIG. 20 is a perspective elevation of an antenna array in accordance with a second embodiment;

FIG. 21 is a plan view of the antenna array illustrated in FIG. 21;

FIG. 22 is a side elevation of the antenna array illustrated in FIG. 22, from the direction indicated by an arrow A;

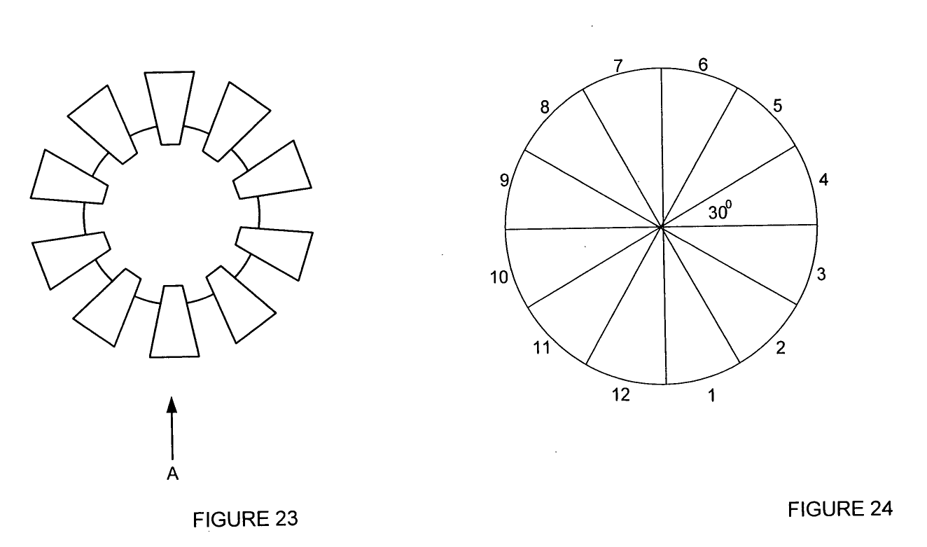

FIG. 23 is a plan view of an antenna array in accordance with a third embodiment; and

FIG. 24 is a schematic diagram illustrating the orientation of major transmission axes of antennas of the antenna array illustrated in FIG. 23.

Referring to FIG. 4, a wireless communications system 100 is illustrated, which demonstrates the operation of a specific embodiment of the present invention. The system 100 comprises a base station 110 and eight mobile stations (labelled respectively MS-1 to MS-8) 115. As illustrated in FIG. 4, the base station 110 is capable of wireless communication with each of the mobile stations 115, and the transmission power profile of transmission by the base station 1 10 towards each of the mobile stations 115 is indicated by substantially elliptical graphical profiles. The correspondence between the particular line used to bound each profile, against the legend in FIG. 4 relates to the operation of the system 100 and will be described in due course.

All of the links illustrated in FIG. 4 (by means of elliptical shapes representing the directional power profiles) are of MIMO format. For the purpose of this description, a MIMO format communications link is intended to encompass SISO, SIMO, MISO and MIMO arrangements.

FIG. 5 illustrates the construction of the base station 110 according to the present embodiment. It will be appreciated that this is by way of example only, and other possible embodiments, including use of an application specific device, would equally be appropriate.

The base station 110 as illustrated in FIG. 5 comprises a general purpose computing device, such as a hand held computer with integrated display and user input means (keyboard, pointing device etc.).

In detail, therefore, the base station 110 comprises a processor 120 operable to execute machine executable instructions organised into programs. These programs can be stored either in a mass storage unit 122 or a working memory 124 in communication with the processor. In the illustrated example in FIG. 5, a series of user applications 126 and a communications controller 128 are illustrated, stored in the working memory 124. In use, the processor (or other associated means) is operable to retrieve program instructions from mass storage unit 122 and temporarily store the same in working memory 124, for convenience and for efficient execution of program instructions in a timely fashion. This is entirely in accordance with known techniques for the management of information storage facilities in a computer.

By means of a general purpose bus 130, the processor is in communication with a communications unit 132 connected to an antenna array 134, providing the physical means by which wireless communication can be affected by the base station 110 with other devices. In this example, the communications unit 132 is operable to provide the physical components to establish wireless communication in accordance with the IEEE 802.11 a standard. The antenna array 134 of the present embodiment will be described and illustrated in further detail in due course.

A user input unit 136 provides means for receiving user input actions, in the operation of the base station. In this example, the user input unit comprises a keyboard and an embedded pointing device, integrated into the base station. A user output unit 138, comprising a display, is capable of presenting to a user information in connection with the operation of the base station.

In use, the base station 110 presents facilities to a user in a generally conventional manner, allowing a user to take advantage of the facilities offered by the base station 110 configured by the user applications 126, including effecting communication with other devices through use of the communications controller 128 configuring operation of the communication unit 132 and the sending of signals through the antenna array 134. The base station 110 is, however, in variance to conventional communications devices in that it provides a facility for management of communication in such a way that enhances signal strength where required while maintaining control of power consumption.

FIG. 6 illustrates the antenna array 134 in further detail. The illustration shows the antenna array 134 comprising a substantially circular frame 140 with eight outwardly radiating antennas 142. The antennas 142 are directional antennas. This means that each antenna 142 has a major axis of transmission; the antennas 142 are arranged such that, as illustrated in FIG. 7, these major axes of transmission are angularly equispaced, so that the angle defined between major transmission axes of adjacent antennas 142 is substantially 45°, as illustrated in FIG. 9. The major axes of transmission of the antennas 42 are substantially coplanar as illustrated in FIG. 8.

FIG. 10 illustrates in further detail the transmission profile of the antennas 142 of the antenna array 134 of the base station 110. FIG. 10 is a graph of transmission power (on a nominal decibel scale) against angular displacement, on a polar plot. Each antenna 142 has a substantially directional transmission profile which has a maximum at the major axis of transmission and which deteriorates sharply on angular displacement away from that major axis.

The transmission power profile of one of the antenna elements of the circular sectorised antenna 142 can be described as a cosine beam pattern, which can be expressed as:
Gᵢ(φ)=\sqrt{2(2n+1)}cosⁿ(φ−θᵢ)

For example, with reference to the antenna 142 aligned with the zero angular axis (marked with a 0) illustrated in FIG. 10, the maximum is designated with 20 decibels of receivable power and, on angular displacement of substantially 30° away from this maximum, the receivable power degrades substantially 10 decibels. This is a significant loss of signal strength, for a device in communication with the base station 110, which displaces away from one of the eight major axes of the antenna array 134, and will result in consequential deterioration in signal to interference plus noise in a received signal at the device in communication with the described base station 110.

The total power of all sectors of the antenna array 134 is to be determined as the same as the power of that an omni-antenna applied to the base station. For instance, in the specific case that a base station is to be provided with the equivalent radiated power of an omni-antenna at 100 mW, the emitted energy of each sector can be just below 100 mw.

Moreover, due to the operation of the system as will be described, the overall power consumption of the sectorised antenna will be far lower than the equivalent omni-antenna, as it is not required for all sectors of the antenna to be transmitting simultaneously.

It will be appreciated that, given that the base station provides a specific embodiment of the invention in terms of control of a sectorised antenna array, the mobile station or stations can also be provided with a sectorised antenna, or may be provided with an omni-directional antenna, depending on the need of power efficiency or simplicity of control.

It will further be appreciated that adaptive array processing can be operated at the mobile station. The power available on each sector can be detected by transmitting power separately on each individual sector.

Returning to FIG. 4, the operation of the base station 110 in establishing wireless communications with the mobile stations 115 will now be described with reference to FIGS. 11 to 13.

FIG. 11 illustrates a method executed in the base station 110 on establishing the scheduling of communication with the mobile stations 115 in the network. It will be appreciated that other processes, such as signing a mobile station on to the network may need to be performed, depending on the network communications protocol employed at the time.

In an initial step S1-2 of the method illustrated in FIG. 11, a power detection signal is sent as a broadcast from all sector transmitters 142 of the antenna 134 of the base station 110. The structure of this message is predetermined, and will now be described.

Next, in step S1-4, a scheduling process is initialised. This scheduling process is illustrated in further detail in FIG. 12, and is intended to determine a series of scheduling decisions for communication between the base station 110 and the various mobile stations 115 registered into the network.

As illustrated in FIG. 12, the initialisation process starts, in step S2-2, by scheduling the mobile stations to corresponding sectors on the basis of feedback information. This step is exemplified by the process illustrated in FIG. 13. The process of FIG. 13 provides a first step S3-2 in which the best fit is identified for scheduling a given sector ID and power data. Then, in step S3-4, the mobile stations are scheduled to corresponding sectors on the basis of the feedback information.

Then, after execution of step S2-2, in step S2-4, for all sectors scheduled with more than one allocated mobile station, these are scheduled in the time, frame or frequency domains to prevent conflict.

Thus, after execution of the process illustrated in FIG. 12, the various scheduling decisions are communicated to the mobile stations in step S1-6.

The scheduling decisions made in respect of this example are illustrated in FIG. 4. In order to communicate with mobile stations MS2 and MS8, the base station uses the same sector. Thus, these are multiplexed in the time domain—MS2 is communicated within a time frame labelled t2, and MS8 in time frame t3.

A second embodiment of the invention is illustrated in FIG. 14, taking advantage of the features of the invention at two communications devices 210 in a MIMO communications system. Three reflected paths between the devices are illustrated, which are nominally a base station (BS) and a mobile station (MS) but it will be appreciated that this designation does not preclude a more decentralised communications approach, such as in an ad hoc network.

The arrangement illustrated in FIG. 14 takes advantage of the fact that the angularly sectorised array of antennas of each communications device 210 is a multiple antenna arrangement such as can be used in MIMO communication, once establishment of suitable paths and path responses has been established, using the scheduling process to identify MIMO paths to be used in MIMO communication.

A third embodiment of the invention will now be described with reference to FIGS. 15 to 18 of the drawings. This embodiment of the invention uses paired sector detection to shorten the overhead, in terms of the guard time required for sector switch. FIG. 15 illustrates a first arrangement where adjacent pairs of sectors are operated as-one, whereas FIG. 16 operates with opposite sectors being operated at the base station as-one.

It will be appreciated that these are merely two examples of possible operation in accordance with the invention, and any two sector combination is possible, depending on system design and application. In each case, the order and arrangement of paired-sectors is preset and known to the mobile station.

In operation, the base station in each MAC frame sends a pair-signal through each paired-sector to the mobile stations. It will be appreciated that the pair-signal can be of any format, recognisable by the mobile stations.

On the other hand, power detection can be conducted, in accordance wit the invention, in terms of individual sectors, pairs of sectors, or combinations of pairs and individual sectors.

In this example, each mobile station is provided with an omni-antenna. However, it would be possible to provide the mobile stations with sectorised antennas in which case, with this configuration, it would be possible to operate adaptive array/array optimisation at the mobile stations.

For this sectorised MIMO system, a MAC frame format is to be defined between the base station and the mobile stations, to enable the system to operate. An example of a specific example of a suitable MAC frame and its operation is described below with regard to FIG. 18. To that end, paired-sector detection is presented to support the MAC frame.

FIG. 18 illustrates the structure of successive MAC frames in a communications protocol. In FIG. 18, the nomenclature is as follows:

m—number of paired-sectors;

n—number of users/MSs observed;

p—number of users/MSs supported;

It can be seen that there are m BCH transmitted to all MSs. Each BCH represents a paired-sector. Based on BCHs, each MS can identify its suitable sectors. If MS want to transmit, it has to send a request to RCH. There are n RCHs available for n users to send a request on a MAC frame. FCH and ACH are for supported users within this MAC frame.

The MAC frame structure is required to support this multiple-sector system. Each sector of the antenna 134 is assigned a sector ID. The MAC frame comprises a sequence of broadcast channels (BCHs). The BCHs provide a facility for the secorts to broadcast information, for possible reception by mobile stations.

The number of BCHs in this example is equal to the number of sectors the BS is using. Equally, there could be an upper limit based on the number of users supported.

After the sequence of BCHs (each of which has a fixed duration), a sequence of Frame channels (FCHs) and Access Channels (ACHs) (combinations of which are considered as protocol data units (PDUs)) are conveyed by the base station. A FCH is a transport channel that is broadcast and which carries the frame control channel; an ACH conveys the result of previous access attempts made in the random access phase of the previous MAC frame. The FCH is not transmitted if no traffic is scheduled for that sector in the current frame.

Then, a sequence of random channels (RCHs) follows after the uplink phase. At least one RCH is allocated per user intending to observe. The frame also contains at least one downlink (DL) phase and/or uplink (UL) phase for a particular sector if the corresponding FCH is present.

For each sector during the link setup, the critical parameter used by a mobile station MS in determining its suitable sector(s) is the link power. Conventional communication techniques between a base station and a mobile station are based on each sector, which thus requires additional overhead. In this example, a process of detecting paired sectors is described.

As noted above, FIG. 15 shows an example of a typical pairing arrangement in accordance with a specific embodiment of the invention.

Sector identifications (IDs) are assigned by the sequence of paired-sectors and the sequence of the paired-sectors is known to both BS and MS. The IDs are assigned to each sector but the usage of UL and DL is different as shown in Table 1 as an example.

TABLE 1

| | Paired- | Down Link | |
|---|---|---|---|
| Sectors | sectors | IDs | Up Link IDs |
| 1 | 1 | 00 | 000 |
| 2 | | | 001 |
| 3 | 2 | 01 | 010 |
| 4 | | | 011 |
| 5 | 3 | 10 | 100 |
| 6 | | | 101 |
| 7 | 4 | 11 | 110 |
| 8 | | | 111 |

Broadcast channel (BCH) transmits on the basis of sector pairs. The preamble of a BCH requires a paired-sector sequence in order to detect the power of both sectors of the paired-sector. After power detection, each individual mobile station determines a set of suitable sectors and feeds back this information to the base station as a request. The request is sent in the RCH part of the MAC frame.

It will be understood that in this example the number of RCHs can be the same as the number of sectors at the base station. However, each RCH corresponds with a mobile station, not with a particular sector.

The access of each user (mobile station) to an RCH is controlled through time division multiplexing. The base station optimises all sectors and assigns the sectors to the supported mobile stations and therefore establish the communication link.

A MIMO format training sequence may be required to transmit through one BCH preamble/mid-amble or DL preamble/mid-amble. The training sequence consists of a number of uncorrelated sequences. In the preferred embodiment, the number of sequences is the same as the number of sectors at the base station; however, this is not essential to the delivery of the invention. Based on the training sequence, each individual mobile station can perform adaptive array/array optimisation to its assigned sectors. This adaptive array/array optimisation is to optimise the signal to noise plus interference ratio.

An example of a ‘three-segment’ preamble is shown in Table 2.

TABLE 2

| | | |
|---|---|---|
| Sector 1 | A | B |
| Sector 2 | A | C |
| | Detection of | Detection of |
| | interference out | self |
| | of the system | interference |

A capacity comparison of the multi-user sectorised MIMO system is shown in FIG. 17. This capacity is based on channel capacity only. It is assumed that:
(1) the base station has sufficient sectors to support the multi-users;
(2) the base station can always schedule the maximum users;
(3) the ratio of optimal power control to mean power is equal;
(4) optimal channel configuration;
(5) capacity is bit/s/Hz/cell.

It is shown that the system capacity increases with the increase of supported users, even though this increase is not linear.

FIG. 19 illustrates a system 200 making further use of a base station 210 similar to that previously described to bring about communication with one or more mobile stations 220. In this case, the base station is in communication with first and second mobile stations. The base station can, by appropriate control of the eight available antennas of the antenna array, simulate the effect of firstly an omnidirectional antenna (dotted line A), secondly a directional antenna (dotted lines B), and thirdly a patch array antenna (dotted line C). These transmission and reception power profiles are generated by the additive effect of using several of the antennas of the array in a grouped way—in the case of the patch array simulating group, the group includes antennas labelled 1 to 4.

FIGS. 20 to 22 illustrate a further embodiment of an antenna array for use in accordance with the invention. The reader will appreciate that the illustrated antenna array differs from that illustrated in FIGS. 6 to 8 merely by virtue of the antenna array comprising two planes of eight arrays, making sixteen antennas rather than the previous eight—this may be advantageous in that it provides a further degree of freedom and thus control of the antenna, when transmitting or receiving signals. It also provides a spatial displacement which can be used to detect spatially modulated signals. However, it does require an additional bit to address a particular antenna. To aid in understanding the similarity between the two antenna arrays, common reference numerals have been used. Using the example illustrated in FIGS. 20 to 22, it will be appreciated that a three dimensional (3D) array can be established specifically for directional MIMO system, where the side horizontal arrays (plan view) can be employed for directional arrays and vertical arrays (side elevation) can be used to form a multiple array transmitter/receiver.

FIGS. 23 and 24 illustrate a further embodiment of an antenna array for use in accordance with the invention. The reader will appreciate that the illustrated antenna array differs from that illustrated in FIGS. 6 to 8 merely by virtue of the antenna array comprising ten arrays rather than the previous eight—this may be advantageous in that it provides further control over the angular modulation available in the system, whereas requiring an additional bit to address a particular antenna.

It will be appreciated that, firstly, further programs, other than those illustrated in FIG. 12, may be stored in working memory 124 to enable operation of the base station, such as an operating system or other programs designed to configure the performance of background tasks. Secondly, all or a portion of the instructions comprising the user applications 126 and the communications controller 128 can be stored, from time to time, in the mass storage unit 122, depending on the capacity of the working memory and the extent to which rapid access is required by the processor 120.

Normally, a working memory provides rapid access but may be limited in capacity, while a mass storage unit (such as a magnetic disk drive) provides substantial storage capacity, but can only offer limited data access speed. However, it is possible to allocate capacity in a mass storage unit to act as additional, or “virtual” memory, under control of a suitably configured operating system.

While the present invention has been described, by way of examples involving a base station and mobile stations—i.e. a centrally controlled network, it will be appreciated that a more ad-hoc network could also be implemented in accordance with the invention.

1. A communications device for use in MIMO communications, comprising antenna means including an angularly sectorised array of substantially directional antenna elements.

2. A device according to claim 1 wherein the antenna elements are aligned relative to each other such that primary directions of said substantially directional elements substantially radiate from a single point

3. A device according to claim 2 wherein the antenna elements are substantially angularly equispaced.

4. A device according to claim 1 and including means for generating a transmission signal at the antenna elements and means for detecting a received signal at the antenna elements, wherein the transmission and reception gains of the antenna elements are independently controllable.

5. A device according to claim 4 and including scheduling means, operable to control transmission and reception gains of the antenna elements to isolate communication of said device with one of a plurality of other devices.

6. A device according to claim 5 wherein the scheduling means is operable to broadcast a scheduling signal, via said antenna, and to determine, on the basis of response information from other devices with which said device is in communication in use, an appropriate directional communication schedule for use of said directional antenna elements.

7. A device according to claim 1 and including a controller operable to control operation of the antenna elements, the controller including allocation means for allocating the antenna elements into groups of at least two elements for simultaneous operation of the antenna elements within a group.

8. A device according to claim 7 wherein the allocation means is operable to allocate elements into groups of two.

9. A device according to claim 8 wherein the allocation means is operable to allocate groups of elements wherein each group comprises two adjacent elements.

10. A device according to claim 8 wherein the allocation means is operable to allocate groups of elements wherein each group comprises two diametrically opposed elements.

11. A device according to claim 1 wherein the antenna comprises first and second pluralities of antenna elements, each said plurality of antenna elements being arranged so that their primary transmission/reception beams are collectively substantially co-planar, and said respective planes of said first and second pluralities being substantially parallel.

12. A system for the communication of information, comprising a plurality of communications devices, at least one of said devices being a communications device in accordance with claim 1.

13. A method of conducting communication in a MIMO system, comprising the steps of determining, for a given device, a preferred direction of communication with other devices in the system, and scheduling communication with said other devices in directions corresponding to said detected preferred directions of communication.

14. A method in accordance with claim 13 wherein, in the event that said device has more than one device with which it is preferred to communicate in a given direction, the method comprises the step of scheduling communication with said devices sharing said preferred direction with reference to time and or frequency.

15. A computer program product for configuring a device according to claim 5, and carrying processor executable instructions for execution at said device to configure said device to perform the steps of claim 13.
